(19) United States
(12) Patent Application Publication
(10) Pub. No.: US 2012/0310972 A1
(43) Pub. Date: Dec. 6, 2012

(54) SYSTEMS AND METHODS FOR REMOTE BIOMETRIC IDENTIFICATION

(75) Inventor: Charles WOHL, The Woodlands, TX (US)

(73) Assignee: SyMPL Technology, Inc.

(21) Appl. No.: 13/151,273

(22) Filed: Jun. 2, 2011

(51) Int. Cl. G06F 17/30; G06F 19/00

(52) U.S. Cl. 707/769; 702/19; 707/E17.014

(57) ABSTRACT

A portable biometric identification device includes a processor and a memory operably coupled to the processor. A biometric sensor configured to take a measurement of a biometric phenomenon is operably coupled to the memory. A wireless transceiver is configured to transmit at least an indication of the measurement of the biometric phenomenon to another device. The method may include capturing one or more sets of biometric data and transmitting the one or more sets of biometric data to a local server. The method may also include receiving at the local server at least one of the one or more sets of biometric data and comparing the manipulated data to entries of a local data base before sending the biometric data on to a remote data base.

### FIELD OF THE INVENTION

The present invention relates generally to providing wireless communications from various sensors to fixed or portable collection devices, and/or associated servers.

### BACKGROUND OF THE INVENTION

In World War II, decks of cards were used to help identify aircraft. Pictures of both friendly and enemy aircraft were placed on cards for soldiers to easily learn to identify planes. Other cards could be arranged in patterns to provide maps. During the Gulf War, US soldiers used a deck of cards with the pictures of the most wanted members of the overthrown Iraqi government. Each of these cards provided a small visual identifier of what was potentially being observed.

A collection of photographic images is similar to a collection of stored templates of biometric data. Each new person is enrolled by feature extraction from a sensor response, usually after some pre-processing, thus creating templates for each person. Note that a template stores only that information used in making a comparison to save storage space. When a new person has a sensor response made, a new template is compared to the data base of stored templates.

### SUMMARY OF THE INVENTION

A portable biometric identification device may include a processor and a memory operably coupled to the processor. A biometric sensor is configured to take a measurement of a biometric phenomenon and is operably coupled to the memory. A wireless transceiver configured to transmit at least an indication of the measurement of the biometric phenomenon to another device is also included.

A method may include capturing one or more sets of biometric data and transmitting the one or more sets of biometric data to a local server. The method may also include receiving at the local server at least one of the one or more sets of biometric data and comparing the manipulated data to entries of a local data base.

### BRIEF DESCRIPTION OF THE DRAWINGS

The invention is hereinafter more particularly described by way of example only with reference to the accompanying drawings, in which:

FIG. 1A is a block diagram illustrating a system according to one embodiment of the present invention.

FIG. 1B is a block diagram illustrating another system according to one embodiment of the present invention.

FIG. 2 is a block diagram illustrating a device having a plurality of sensors according to one embodiment of the present invention.

FIG. 3 is a block diagram illustrating another device having at least one sensor according to one embodiment of the present invention.

FIG. 4A is a flowchart illustrating a method according to one embodiment of the present invention.

FIG. 4B is a flowchart illustrating a local data usage method according to one embodiment of the present invention.

FIG. 5 is a flowchart illustrating a remote server method according to one embodiment of the present invention.

FIG. 6 is a diagram illustrating interlinking data bases, according to one embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention as defined by the appended claims.

### DETAILED DESCRIPTION OF EMBODIMENTS OF THE INVENTION

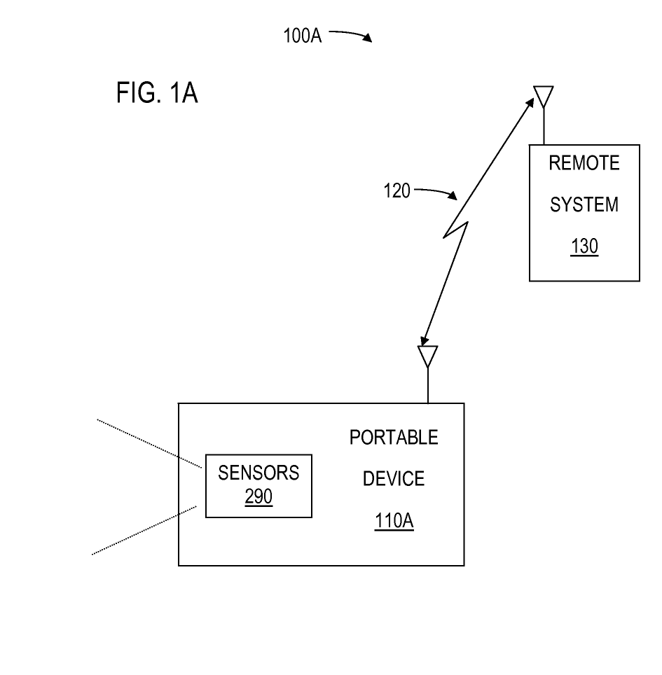

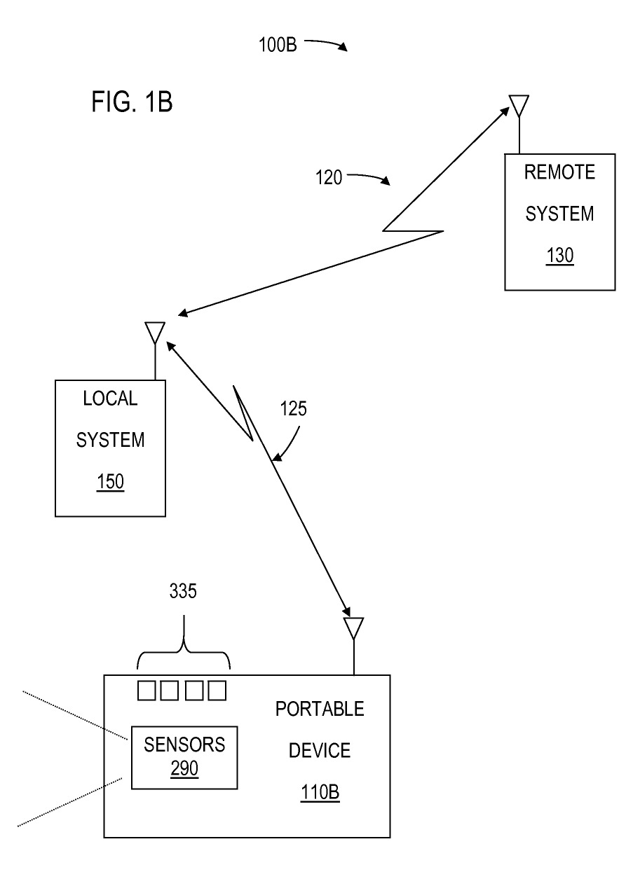

Turning to FIG. 1A, a system 100A is shown for providing wireless communications 120 from various sensors 290 to an associated remote system 130. The sensors 290 are associated with a portable device 110. The portable device 110 is configured to communicate measurement data from the sensors 290 and/or information gleaned from or transformed from the measurement data from the sensors 290 to the remote system 130.

As is discussed in detail below, the sensors 290 may include one or more of the following biometric sensors as well as non-biometric sensors. Fingerprint sensor technologies may include optical, infrared, laser, or capacitive technologies for electronic collection of single fingerprints, electronic collection of dual (two at one time) fingerprints, or electronic collection of “slap and roll” fingerprints. Iris capture technologies may include single iris or dual iris capture using camera technology with optional subtle infrared illumination reducing specular reflection from the convex cornea to create images of the detail-rich, intricate structures of the iris. Electronic capture of facial characteristics for computer analysis of the facial structure may include a number of points and measurements, including the distances between key characteristics such as eyes, nose and mouth, angles of key features such as the jaw and forehead, and lengths of various portions of the face. Electronic capture of ear characteristics for computer analysis of the ear structure may include a number of points and measurements, including the distances and angles between key characteristics such as ear canal, helix and lobe, and lengths of various portions of the ear. Electronic capture of hand or finger vein pattern characteristics for the computer analysis and matching may be used. Electronic capture of handwriting is contemplated using a finger, pen, or stylus on a touch-screen. Voice stress analyzers and vocal analyzers are also contemplated. In various embodiments, two or more sensors are present.

As shown in FIG. 1B, a system 100B is shown for providing wireless communications 125 from various sensors 290 to an associated local system 150. The sensors 290 are associated with a portable device 110B. The portable device 110B is configured to communicate measurement data from the sensors 290 and/or information gleaned from or transformed from the measurement data from the sensors 290 to the local system 125. The local system 125 is configured to wirelessly communicate 120 received data from the sensors 290 and/or received information gleaned from or transformed from the measurement data from the sensors 290 to the remote system 130, when such wireless communication is available and desired. In other embodiments, the local system 125 and the remote system 130 are coupled by a wired connection, a satellite connection, or a combination of wired and wireless connections. Indicators 335 associated with the portable device 110B allow for the user to be notified of various actions either performed or not performed, such as successful recording of biometric data or a failure in the recording of the biometric data, successful transmission to the local server or an acknowledgement of reception by the local server, a positive or negative immediate identification through the biometric data, a positive or negative local identification from the local server, and/or a positive or negative remote identification from a remote server.

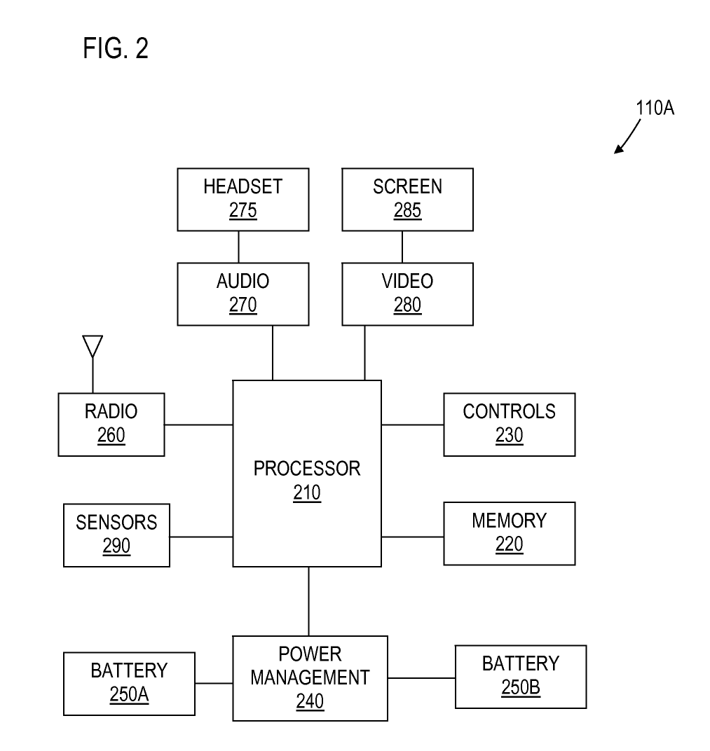

In FIG. 2, a exemplary block diagram of the portable device 110A is illustrated. Note that while components of the portable device 110A are shown as separate blocks, functionality of certain blocks may be integrated into other blocks in various embodiments of the present invention. Various examples of that mixing and integration are disclosed explicitly within, but others are contemplated. A processor 210 provides processing power to run an operating system and programs in the portable device 110A. The processor 210 may also control wireless communications through a radio 260. A memory 220 is operably coupled to the processor 220. The memory 220 stores short term data and/or the operating system and long term data, such as hardware configuration data for the portable device 210. A plurality of controls 230 are operably coupled to the processor 210 to allow for a user to provide input to the processor 220. Power management 240 is operably coupled to the other components of the portable device 110A to provide adequate power to the other components. As shown, two batteries, 250A and 250B, are operably coupled to the power management 240. As will be discussed below, the two batteries are configured to allow for the removal and replacement of the batteries 250A and 250B while the portable device 110A is operating. As mentioned previously, a plurality of sensors 290 may be operably coupled to the processor 210. Each of the plurality of sensors 290 is configured to receive measurement data and provide the measurement data or information extracted from or transformed from the data. Audio 270 and video 280 may be operably coupled to the processor 210 to allow for an optional headset 275 and a screen 285, preferably a touch screen 285.

In one embodiment, the processor 210 is an Intel® ATOM™ processor, available from Intel Corp. In another embodiment, the processor 210 is an ARM® processor, such as the ARM11 or the ARM Cortex™ series. ARM-based processors are available from several different manufacturers, such as Freescale™ Semiconductor, Texas Instruments Inc., or Toshiba America, Inc. In various embodiments, the processor 210 may operate at 600 MHz, 800 MHz, 1 GHz, or at a higher frequency. In various embodiments, the processor 210 may have one or more cores configured to operate jointly or independently. In one embodiment, the operating system running on the processor 210 is a version of Windows® from Microsoft® Corp., such as Windows 7 or Windows XP Pro. In another embodiment, the operating system is a version of Linux®, such as Android by Google™ Inc. or bada by Samsung Electronics Co., Ltd. The processor 210 preferably includes security hardware or firmware to handle secure communications, such as end-to-end encryption through cryptographic software and/or hardware suites, including algorithms such as AES-128, Diffie-Hellman, key exchanges, SHA-1, HMAC-SHA1, VPN, etc. The processor 210 may also include interfaces for ATA, Ethernet, GPIO, I2C, IrDA, SDIO, SPI, UART, USB, and/or other wired communications protocols. In other embodiments, the processor 210 is a custom processing device that is fixed (or uses firmware) to perform only those functions required by the portable device 110A.

In various embodiments, the processor 210 may include some amount of the memory 220, as RAM, ROM, flash memory, or a PROM distinct from any on-board cache memory. The processor 210 preferably includes, or is operably coupled to, a memory interface for the memory 220. The memory 220 may include a plurality of memories 220. The plurality of memories 220 may include DRAM 220, SRAM 220, ROM 220, flash memory 220, etc. and may include removable memory in one or more various forms, such as on an SD card or USB device. The ROM 220, SRAM 220, and/or flash memory 220 may store system configuration data. In one embodiment, the memory 220 includes at least 1 GB. In one embodiment, the memory 220 includes at least 32 GB as removable memory 220.

In one embodiment, the controls 230 are incorporated through the operating system running on the processor 210 through the touch screen 285. A plurality of soft buttons defined by software provide a user the ability to control the device 110A. In another embodiment, one or more buttons on the outside of the device 110A are used to provide control of the operation of the device 110A. Contemplated controls may include power on/off, power-saving mode on/off, volume control, component on/off (such as the radio 260, sensors 290, etc.), automatic sensor activation and upload, etc. The touch screen 285 may also be used to capture handwriting samples, such as signatures.

The power management 240 preferably includes any necessary transformers and other hardware for converting power from an external source or the one or more batteries 250A and 250B into the voltages and currents required for operation of the other components of the portable device 100A. In one embodiment, the power management 240 includes variable clocking for the processor 210 and/or other components to slow power consumption, preferably in a standby mode or sleep mode. In another embodiment, the power management 240 includes variable power delivery to the processor 210 and/or other components, preferably in a standby mode, sleep mode, or a powered down state.

The power management 240 is configured to allow for removal and replacement of either the battery 250A or the battery 250B while the portable device 110A is in normal operation. In one embodiment, the power management 240 is configured to allow for both batteries 250A and 250B to be removed and replaced while the portable device 110A remains in full operation for a predetermined length of time for battery replacement. The power management 240 may include a small onboard backup battery to provide normal power for the predetermined length of time. In one embodiment, power management 240 includes a capacitive charge to provide normal power for the predetermined length of time for battery replacement. In one embodiment, the predetermined length of time for battery replacement is at least 30 seconds. In another embodiment, at least 1 minute, in another embodiment, at least 2 minutes, and in another embodiment, at least 3 minutes. The batteries 250A and 250B are preferably lithium ion batteries, although other battery technologies are contemplated. The portable device 110A may be charged or operated on AC or DC external power. In one embodiment, the portable device 110A operates on a single battery 250.

In one embodiment, the radio 260 is integrated wholly or in-part with the processor 210. In various embodiments, the radio 260 operates on one or more frequencies, such as 800 MHz, 900 MHz, 1.8 GHz, 1.9 GHZ, 2.4 GHz, 4.9 GHz, 5.0 GHz etc., and/or one or more protocols, such as satellite telephony, encrypted AM, encrypted FM, 4G, HPSA+, HPSA, 3G, EDGE, GPRS, GSM, CDMA, WiMAX under IEEE 802.16, microwave, WiFi under IEEE 802.11 abgn, and/or Bluetooth, etc. In one embodiment, the radio 260 is configured to support the CoCo® networking protocol for secure mesh communications.

In some embodiments, there may be a plurality of radios 260 in the portable device 110B. Various ones of the plurality of radios 260 may be integrated with other components of the portable device 110A, including the processor 220, one or more sensors 290, the memory 220, or the controls 230. Each radio 260 may operate using a different frequency, mode, or technique from other radios 260.

The audio 270 and the video 280 may include codecs and software manipulation as well as hardware components, such as speakers or the headset 275, as well as the screen 285 or a video-out port for external viewing on a larger screen. The audio 270 and/or the video 280 may provide an indication to the user of success or failure for the various operations of the device 110A or an event. Examples of events include sensor data acceptance success or failure, sensor data transmission or reception, positive or negative identification, etc.

As previously mentioned, the sensors 290 may include one or more biometric sensors 290. A fingerprint pad compatible with FIPS 201.1, a camera for iris capture, full or partial facial recognition, and/or vein pattern, and a microphone for voice stress and vocal analysis are all contemplated. The term ‘biometric sensor’ means the hardware and software required to perform a data capture for either data manipulation before analysis or raw data analysis for the immediate and/or future identification of a person, living or dead. Biometric sensors are usually connected to “host” devices, (computers, laptops, cellular phones, specialized devices, servers) via USB, parallel, serial, special connectors, and/or are internal to the collection device.

The sensors 290 may also include non-biometric sensors, for example, for determining and/or recording location, weather, proximity, communication and/or record-keeping. Examples of such sensors include GPS, Galileo GNSS, GLONASS, Compass navigation, temperature, radar, single camera or multiple cameras for video recording and/or video conferencing, one- and multi-dimensional bar code scanner (or camera), such as QR code, etc. Location sensors may be used to help the user identify a location through triangulation or visual indications.

In a preferred embodiment, user interface software, either running on the operating system or directly on the processor 210, allows the user at least to take sensor measurements, communicate either the sensor measurements or an indication thereof to another device or party, and receive information in response to the sensor measurements or indication thereof. The user interface software may automate the process of capturing, recording, manipulating, comparing, sending, and receiving. In other embodiments, one or more processes of capturing, recording, manipulating, comparing, sending, and receiving may manually initiated, while the others remain automatic. Not all embodiments contemplated are configured for all of these actions.

In a preferred embodiment, a local data base of biometric data is stored within the memory 220, either in DRAM 220 or in SRAM 220. The local data base is configured to be queried by a process running on the portable device 110A in response to a recording of biometric data from one or more of the biometric sensors 290. The biometric data may be raw or may be manipulated before comparison, depending on the format of the biometric data stored in the local data base. Manipulation of data may include error correction, filtering, compaction, encryption, decryption, convolution, and/or conversion or transformation using a pre-determined algorithm. In another embodiment, one or more data bases include non-biometric data, such as bar code indicia. These non-biometric data may also be manipulated or

In a preferred embodiment, the portable device 110A is a PocketPAD™ available from SyMPL Technology, Inc. The PocketPAD™ may have dimensions of 13 cm×20 cm×5.7 cm with a weight of 1 kg and be operable in harsh and explosive environments. Embodiments of the PocketPAD™ may be submersible.

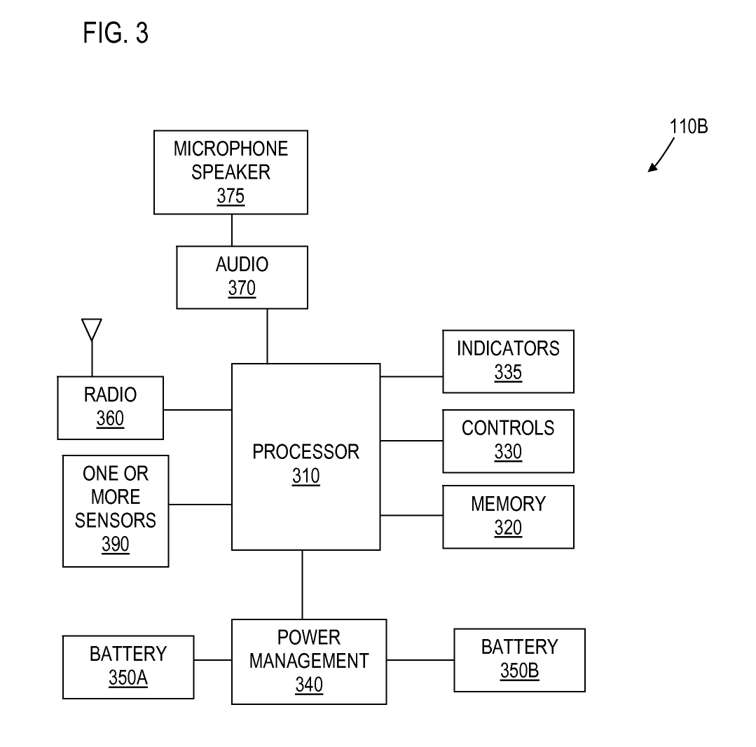

Turning to FIG. 3, a exemplary block diagram of the portable device 110B is illustrated. Smaller and more compact than the portable device 110A, the portable device 110B is generally similar in many ways to the portable device 110A, and the previous description of the portable device 110A is applicable to the portable device 110B. As shown, the portable device 110B does not include a video output. In general, a processor 310 provides processing power to run an operating system and programs in the portable device 110B. The processor 310 may also control wireless communications through a radio 360. A memory 320 is operably coupled to the processor 320. The memory 320 stores short term data and/or the operating system and long term programs and data, including hardware configuration data for the portable device 310. A plurality of controls 330 are operably coupled to the processor 310 to allow for a user to provide input to the processor 320. A plurality of indicators 335, preferably on the front of the portable device 110B, provide the user an indication or indications of either status of the portable device 110B and/or status of a sensor 390 or program or data associated with one or more of the sensors 390. Power management 340 is operably coupled to the other components of the portable device 110B to provide adequate power to the other components. As shown, two batteries, 350A and 350B, are operably coupled to the power management 340. In one embodiment, the portable device 110B operates on a single battery 350. As mentioned previously, one or more sensors 390 may be operably coupled to the processor 310. Each of the one or more sensors 390 is configured to receive data and provide the data or information extracted from or transformed from the data. Audio 370 may be operably coupled to the processor 310 to allow for microphone and speakers 375.

A plurality of indicators 335 provide an indication to the user of a status of either the device 110B or an event. Examples of events include sensor data acceptance success or failure, sensor data transmission or reception, positive or negative identification, etc. In one embodiment, the indicators 335 are visual, while in another embodiment, the indicators are auditory. In another embodiment, the indicators 335 are of multiple types.

In a preferred embodiment, the portable device 110B is a FingerPAD™ available from SyMPL Technology, Inc. with a fingerprint sensor.

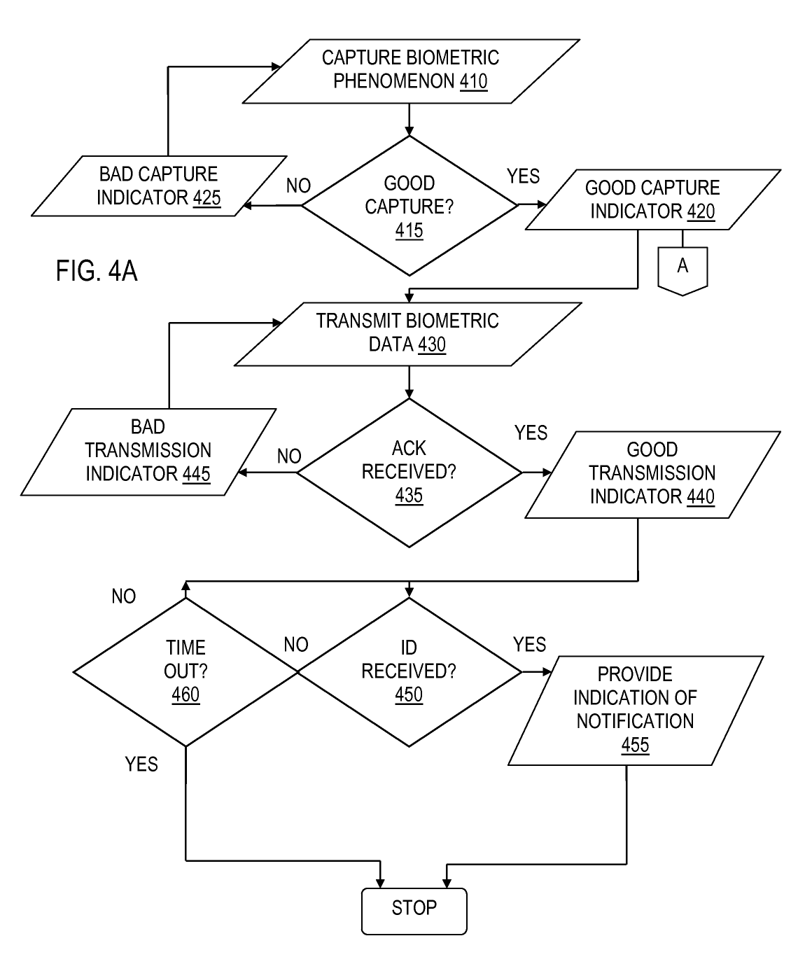

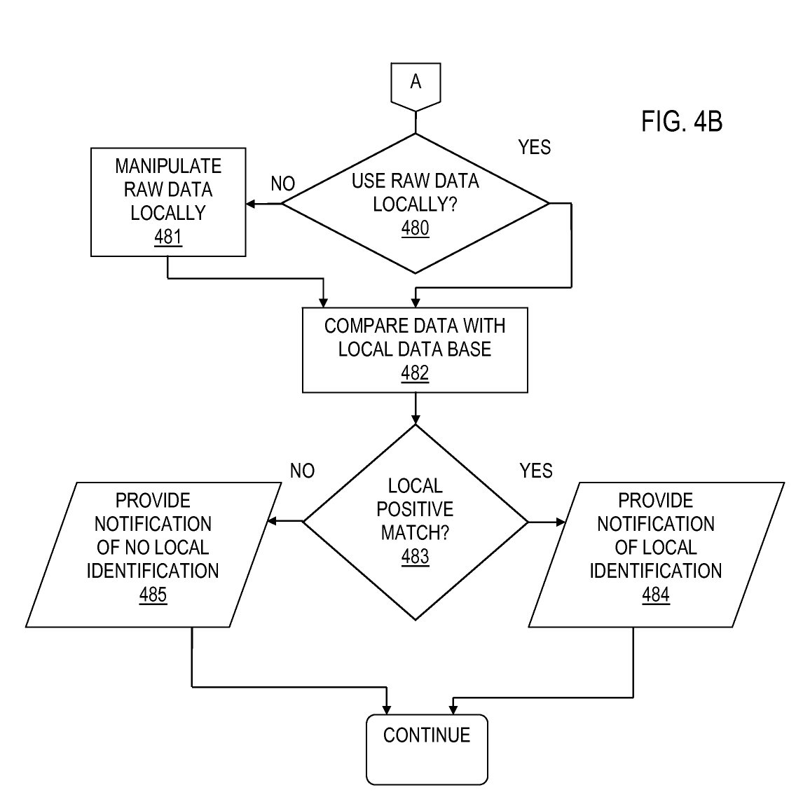

Turning now to FIG. 4A, the flowchart illustrates a method of capturing biometric phenomenon, transmitting biometric data, and comparing with a data base at another location, according to one embodiment of the present invention. The method includes capturing biometric phenomenon, in block 410. The data captured are recorded at the local device, such as the portable device 110A or 110B. The method preferably checks for a good capture, in decision block 415. A measure of a good capture depends on the biometric sensor used and the native data format for that biometric sensor, which may be sensor 290 or 390. In general, a good capture is defined as a data capture, which is capable of being recorded, of sufficient quality to make a comparison to one or more entries in a data base of either raw data from earlier captures or modified data from earlier captures. The earlier captures may be from any source. If there was not a good capture, then preferably the bad capture indicator is activated in block 425 and the method returns to block 410 for a new data capture. If there was a good capture, then preferably the good capture indicator is activated in block 420 and the method continues.

The method next transmits the biometric data to another device, in block 430. The another device may be a local server. The another device may be a remote server. The another device may be an intermediate between the device performing the method and a local server or a remote server. In a preferred embodiment, an acknowledgement will be sent by the another device when the transmitted biometric data are received, in block 435. If there was not a good reception, then preferably the bad transmission indicator is activated in block 445 and the method returns to block 430 for a new data transmission. If there was a good reception, then preferably the good transmission indicator is activated in block 440 and the method continues.

The method preferably continues after actions by the another device and/or other devices. The biometric data transmitted, or a modified version of the biometric data or manipulated biometric data, are compared to one or more entries in a data base of similar data. The biometric data may be modified or manipulated at the another location before comparison.

The method continues once an identification or an indication of an identification is received based on the transmitted biometric data in decision block 450. If no identification is received, then eventually a time out will be decided in decision block 460. Preferably the time out period is user defined. In other embodiments, a set length of time is used, such as ten minutes. If an identification is received within the time out period, then an indication of the notification of identification is made in block 455.

In an embodiment of the method with a local server, once a good capture is indicated in block 420, the method continues as illustrated in FIG. 4B. The raw biometric may be used locally in decision block 480. If not, the method manipulates the raw data locally in block 481. The manipulation may include filtering or conversion to another form or format. In general, manipulation includes changing the data into a form or format that will be used in the comparison in the local data base in block 482. If the raw data are used locally, then the raw data are be used in the comparison in the local data base in block 482.

Once the comparison is made, then the method decides if a local match has been made in decision block 483. If a positive match has been made, then notification of local identification is given in block 484. If no local positive match has been made, then notification of no local identification is given in block 485.

The distinguishing feature between the local server and the remote server is the size of the data base of biometric data for comparison. The local server includes a limited-sized data base of a very small number of entries. Examples of limited-sized data bases include a most wanted list and members of a specific organization. Since a local server is designed to provide almost immediate feed-back in the field, so the size is dictated by the physical size, weight, and processing power of the local server and the transportation available for the local server. A ship-board local server may include a larger local data base than a police patrol car local server or a SEAL team unit local server.

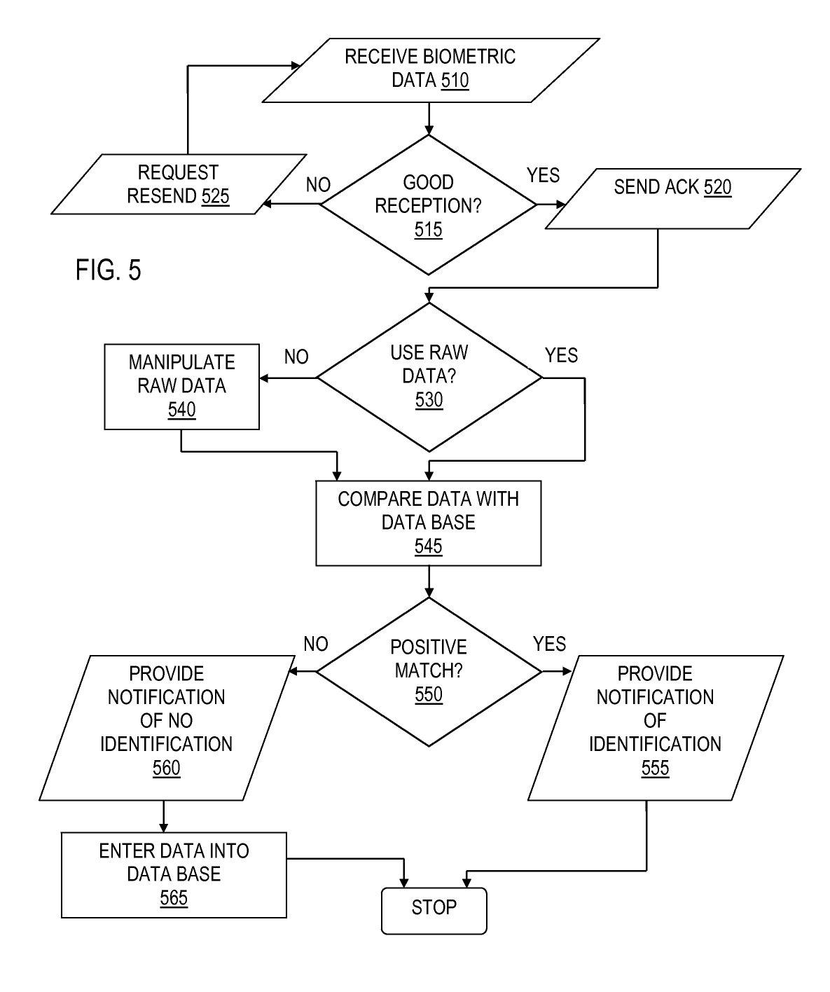

Turning now to FIG. 5, a flowchart illustrating a remote server method according to one embodiment of the present invention. It should be appreciated that the operation of the remote server is similar to the operation of the local server as shown in FIG. 4B.

The method includes receiving biometric data, in block 510. The data received are recorded locally at the remote server. The method preferably checks for a good reception, in decision block 515. A measure of a good reception in general would be reception of correct checksum or similar known means of checking reception. If there was not a good reception, then preferably a request is made to resend the data in block 525 and the method returns to block 510 for a new data reception. If there was a good reception, then preferably an acknowledgement signal is sent back to the transmitting device in block 520 and the method continues.

The raw biometric may be used in decision block 530. If not, the method manipulates the raw data in block 540. The manipulation may include filtering or conversion to another form or format. In general, manipulation includes changing the data into a form or format that will be used in the comparison in the data base in block 545. If the raw data are used, then the raw data are be used in the comparison in the data base in block 545.

Once the comparison is made, then the method decides if a positive match has been made in decision block 550. If a positive match has been made, then notification of identification is given in block 555. If no positive match has been made, then notification of no identification is given in block 560. In a preferred embodiment, if there is no identification, then the biometric data being compared, whatever the form or format, is entered into the data base in block 565, preferably along with all available other information.

Further understanding of the present invention may be had by considering the details of the following real-world examples, such as a traffic stop by a police officer, a customs agent at a border stop, a military patrol, a coast guard stop, or a security checkpoint. An officer, i.e., a user, may carry the portable device 110 (either 110A or 110B). Typically, a lap top or other computer in a patrol vehicle could act as a local server. Once one or more suspects are encountered, the officer may use the portable device 110 to capture one or more biometric sensor data sets of the suspects. The portable device 110 may also audio and/or video record the encounter, using either a forward-pointing camera aimed at the suspects and/or also a rear-pointing camera aimed at the officer. The officer may request to see official identification of the suspects. The official identification may be recorded by the camera. The officer may request that one or suspects say his or her full name or a pre-determined statement and record the audio. The officer may request that the suspects give one or more fingerprints or retinal scan. The officer may take pictures.

The portable device 110 preferably provides an indication for the officer when biometric data or other data captures are successful. Once successful biometric data have been captured and recorded, the portable device 110 may automatically create a communications link to the local server and send the biometric data or a manipulated version of that data. The portable device 110 may automatically search an on-board data base for a biometric match. As will be understood by those of skill in the art having the benefit of this disclosure, the trade-off between communications bandwidth and computing and storage power of the portable device 110 will determine whether raw data or manipulated data are transmitted to other devices. The portable device 110 preferably receives an acknowledgement of successful transmission and provides an indication for the officer when the transmission is successful. In other embodiments, only failures are indicated to the officer. In one embodiment, new biometric data, or modified data such as a template of the biometric data, is added to the on-board data base.

The local server may perform the method outlined in FIG. 4B. Whether or not the method of FIG. 4B is performed, the local server may transmit the biometric data on to other data bases for comparison, typically with a final destination of a remote server with a substantial biometric data base. In the case of fingerprint data, for example, the FBI data base, the Interpol data base, or a military data base are contemplated, although various state police agencies and other agencies or countries may also have substantial data bases. Some data bases may include multiple types of biometric data, or templates, for comparison.

The data set used in a local server or on-board the portable device 110 may be chosen as a sub-set of a larger data base. One way to determine the smaller data set is to have a “most wanted” group, the data base including biometric templates for those individuals that are being sought. In another embodiment, the smaller data set includes those biometric templates that correspond to those individuals most likely to be confused or misidentified as someone else. For example, those individuals with similar names or identification numbers, or even twins, may need to be distinguished rapidly. The test for similarity may include transposed or misspelled letters or digits as well as homophones or homographs.

Another example of a method of use according to the present invention is in the area of medical treatment. Medical personnel, such as a physician, nurse or technician, may be providing treatments to a variety of patients. Proper treatments for one patient may be deadly for another. Medical facilities often use bar-coded identification tags in an attempt to guarantee identification. In one embodiment, a scan of a bar code by the portable device 110 allows the portable device 110 to alert the user that a potential misidentification may occur. A biometric scan of the patent is taken to verify the patient's identity. The portable device 110 may also be used to record treatment notes and/or the patient's vital signs. Visual and/or aural recordings may also be taken concurrently. The portable device 110 may also provide a telemedicine presence for diagnosis or for oversight of the treatment. The portable device 110 may include an on-board data base of those patients most likely to be confused or those patients most likely to be harmed by a misidentification. The local data base may include all of the patients being seen by the medical user or all patients currently at the facility, as examples. The remote data base may include all patients ever at the facility or all patients with acceptable insurance, as examples. In each case, the on-board data base is typically no larger than the local data base, which is smaller than the remote data base. Other data bases may include a data base kept for one or more insurance companies, including currently and possibly former insureds.

Depending on the sensors available on the embodiment of the portable device 110 being used, location, weather, radioactivity measurements, and/or other environmental factors and data may be captured and stored. In one embodiment, non-biometric data are separately captured and transmitted with the biometric data. In another embodiment, non-biometric data are captured and transmitted in conjunction with the biometric data. One example of conjunction is the non-biometric data are integrated, such as video images with digital watermarks. Another conjunction example includes a file format with non-biometric data appended to the biometric data set.

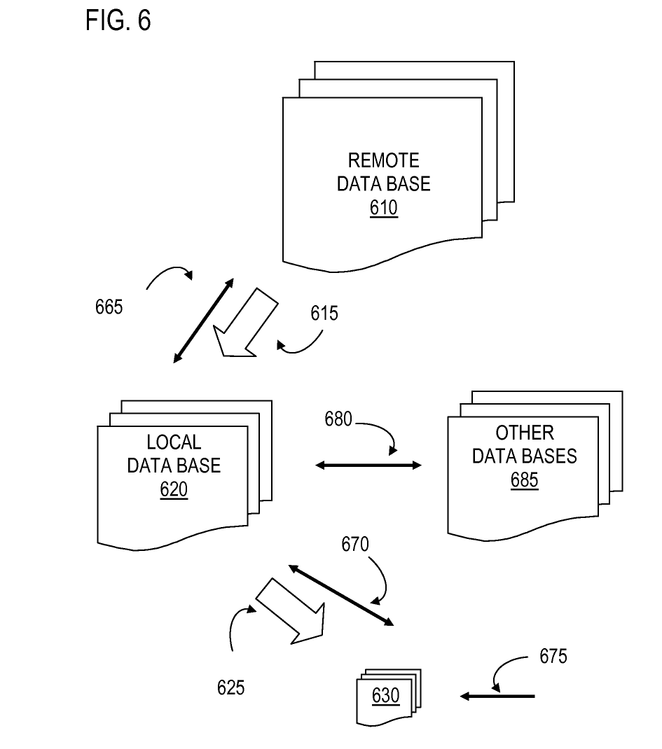

Turning now to FIG. 6, a diagram illustrating interlinking data bases, according to one embodiment of the present invention, is shown. A remote data base 610, as used herein, refers to a sizable data base of biometric data or typically biometric templates for a large number of individuals. A sub-set of data may be extracted (615) to a local data base 620. As mentioned above. the selection criteria for the sub-set in the local data base selection (615) may include the active group based on location, purpose, or other unifying feature, such as user, supervisor, consultant, class, etc. The remote data base 610 and the local data base 620 may also exchange data, including biometric data sets and comparison information, indications, and/or notifications.

The local data base 620 may also exchange data, including biometric data sets and comparison information, indications, and/or notifications with other data bases 685. A sub-set of data may be extracted (625) to an on-board data base 630. As mentioned above. the selection criteria for the sub-set in the on-board data base selection (625) may include the active group based on location, purpose, or other unifying feature. The selection criteria may also include those most likely to be misidentified or confused, based on any reasonably predicted identifier. These identifiers include similarity in, for example, biometric template, name, and/or identification number. The local data base 620 and the on-board data base 630 may also exchange data, including biometric data sets and comparison information, indications, and/or notifications. The on-board data base 630 will also add entries (675) as new biometric scans are made.

Numerous variations and modifications will become apparent to those skilled in the art once the above disclosure is fully appreciated. It is intended that the following claims be interpreted to embrace all such variations and modifications.

What is claimed is:

1. A portable biometric identification device, comprising:
a processor;
memory operably coupled to the processor;
a biometric sensor configured to take a measurement of a biometric phenomenon, wherein the biometric sensor is operably coupled to the memory; and
a wireless transceiver configured to transmit at least an indication of the measurement of the biometric phenomenon to another device.

2. The portable biometric identification device of claim 1, further comprising:
a second biometric sensor configured to take a measurement of a second biometric phenomenon, wherein the second biometric sensor is operably coupled to the memory; and
wherein the wireless transceiver is further configured to transmit at least an indication of the measurement of the second biometric phenomenon to the another device.

3. The portable biometric identification device of claim 1, further comprising:
at least one sensor, different from the at least one biometric sensor, for transmitting at least an indication of sensed data through the wireless transceiver.

4. The portable biometric identification device of claim 1, further comprising:
a user output configured to provide a user with at least an indication when the wireless transceiver has transmitted to another device.

5. The portable biometric identification device of claim 1, further comprising:
a user output configured to provide a user with at least an indication of a received message sent in response to the at least the indication of the measurement of the biometric phenomenon.

6. The portable biometric identification device of claim 5, wherein the received message is an acknowledgement that data was received by the another device.

7. The portable biometric identification device of claim 5, wherein the received message is at least an indication of an identification from the another device in response to the at least the indication of the measurement of the biometric phenomenon.

8. The portable biometric identification device of claim 1, wherein the another device includes a local server including a limited-sized data base of biometric data for comparison with the at least the indication of the measurement of the biometric phenomenon.

9. The portable biometric identification device of claim 1, wherein the another device includes a remote server including a substantial data base of biometric data for comparison with the at least the indication of the measurement of the biometric phenomenon.

10. The biometric identification device of claim 1, wherein the memory includes a limited data base of biometric data configured for comparison with at least the indication of the measurement of the biometric phenomenon.

11. A portable biometric identification device, comprising:
a processor;
memory operably coupled to the processor, wherein the memory includes a limited data base of biometric data;
a plurality of biometric sensors each configured to take a measurement of a biometric phenomenon, wherein each of the plurality of biometric sensors is operably coupled to the memory;
a plurality of sensors each configured to record sensed data;
a wireless transceiver configured to transmit at least an indication of the measurement of the biometric phenomenon taken by each of the plurality of biometric sensors to another device, and wherein the processor is configured to compare the at least the indication of the measurement of the biometric phenomenon against the limited data base of biometric data in the memory;
an input operably coupled to the processor, wherein a user may control processor activities through the input; and
an output operably coupled to the processor, wherein the user may receive status information through the output.

12. A system for portable biometric identification, the system comprising:
a portable biometric identification device, comprising:
a processor;
memory operably coupled to the processor;
a biometric sensor configured to take a measurement of a biometric phenomenon, wherein the biometric sensor is operably coupled to the memory; and
a wireless transceiver configured to transmit at least an indication of the measurement of the biometric phenomenon to a local biometric server; and
the local biometric server, comprising
a server processor;
server memory operably coupled to the server processor;
a limited data base of at least indications of a plurality of measurements of biometric phenomena; and wherein the biometric sensor is operably coupled to the memory; and
a transceiver configured to receive at least an indication of the measurement of the biometric phenomena from the portable biometric identification device.

13. The system of claim 12, wherein the memory of the portable biometric identification device includes a limited data base of biometric data configured for comparison with at least the indication of the measurement of the biometric phenomenon.

14. A method of biometric identification using a local server, the method comprising:
capturing one or more sets of biometric data;
transmitting the one or more sets of biometric data to the local server; and
providing a notification of either an identification or no identification based on the one or more sets of biometric data.

15. The method of claim 14, further comprising:
receiving at the local server at least one of the one or more sets of biometric data; and
comparing the one or more sets of biometric data to entries of a data base at the local server.

16. The method of claim 14, further comprising:
manipulating the at least one of the one or more sets of biometric data at the local server; and
comparing the manipulated data to entries of a data base at the local server.

17. The method of claim 16, further comprising:
updating the data base with the manipulated data if there is no identification.

18. The method of claim 16, further comprising:
transmitting the manipulated data to a remote server for comparison.

19. The method of claim 14, further comprising:
transmitting the at least one of the one or more sets of biometric data to a remote server for comparison.

20. The method of claim 14, further comprising:
comparing the one or more sets of biometric data to a local data base.

21. The method of claim 14, further comprising:
sensing one or more sets of sensed data; and
transmitting the one or more sets of sensed data with the one or more sets of biometric data.

22. The method of claim 14, further comprising:
updating the data base with the one or more sets of biometric data if there is no identification.

23. A method of using a portable sensing device in conjunction with a local server, the method comprising:
capturing one or more sets of sensor data;
comparing at least one of the one or more sets of sensor data to an on-board data base;
providing a notification of either an identification or no identification based on the at least one of the one or more sets of sensor data; and
transmitting the one or more sets of sensor data to the local server.

24. The method of claim 23, further comprising:
upon said providing the notification of either the identification or the no identification, capturing a second one or more sets of sensor data; and
comparing at least one of the second one or more sets of sensor data to an on-board data base; and
providing a notification of either a confirmed identification or a confirmed no identification based on the at least one of the second one or more sets of sensor data.

25. The method of claim 24, further comprising:
providing a notification of either a confirmed identification or no identification based on a notification from the local server in response to said transmitting the one or more sets of sensor data to the local server.

26. A method of configuring data bases, the method comprising:
selecting a subset of a first data base for inclusion in a second data base, where a first one or more criteria are used in the selecting;
selecting a subset of the second data base, where at least one criterion for the selecting is a likelihood of confusion with at least one other entry in the second data base.
